(19) United States
(12) Patent Application Publication
(10) Pub. No.: US 2003/0034651 A1
(43) Pub. Date: Feb. 20, 2003

(54) Corrugated plastic pipe arrangement

(75) Inventors: Tilo Neubauer, Konigsberg (DE); Soren Schroeter, Bamberg (DE)

Correspondence Address: Peter F. Corless, EDWARDS & ANGELL, LLP, P.O. Box 9169, Boston, MA, 02209, US

(73) Assignee: Frankische Rohrwerke Gebr. Kirchner GmbH + Co KG

(21) Appl. No.: 10/218,794

(22) Filed: Aug. 14, 2002

(30) Foreign Application Priority Data
Aug. 14, 2001 (DE) 101 39 899.9

(51) Int. Cl. F16L 17/00

(52) U.S. Cl. 285/396; 285/402; 285/361; 285/903

(57) ABSTRACT

The invention relates to a corrugated plastic pipe arrangement with a first preferably cylindrical pipe body, a second preferably cylindrical pipe body, and a connecting portion including first and second connecting parts respectively associated with one of the pipe bodies, whereby one connecting part includes an engagement extent and the other connecting part a holding region for holding the engagement extent in a holding position in which the pipe bodies are connected to one another.

### FIELD OF THE INVENTION

The invention relates to a corrugated plastic pipe arrangements and in particular to the connection of corrugated plastic pipes with one another.

### BACKGROUND ART

It is known in the art to connect corrugated pipes end to end by way of adapters or the like. Such connection requirements can occur, for example, when corrugated pipes of different materials are to be connected to one another. Furthermore, such needs can arise when corrugated pipes must be connected to one another to bridge large lengths or distances which cannot be achieved with individual corrugated pipe units. It can also be necessary to produce water or liquid tight connections, for instance in liquid conducting systems or in cable protection systems, when the cables are to be protected from humidity.

It can also occur that long corrugated plastic pipes are to be connected to components, for example switch gear cabinets, machine sections, or the like.

Conventional technologies, which also included the insertion of unions or the like, leave a lot to be desired with respect to the simplicity of installation, the multitude of parts and, correspondingly, also cost. The sealing of known systems is also relatively unreliable.

### SUMMARY OF THE INVENTION

It is therefore an object of the present invention to provide a plastic corrugated pipe arrangement, which enables a reliable sealed connection with simple means. It is furthermore an object in accordance with the invention to provide a more cost efficient connection technology as far as corrugated plastic pipes are concerned. Moreover, the multitude of parts is to be reduced in accordance with the invention.

The advantages in accordance with the invention are based on the structure of the connecting portion which is in two parts, whereby first and second connecting parts are respectively integrally formed with the first and second pipe body and whereby the first connecting part includes an engagement extent, while the second connecting part includes a holding region which especially reversibly holds the engagement extent.

This means that a plastic corrugated pipe arrangement is provided which can be continuously produced with a corrugator, whereby at certain, preselected locations, for instance in the region of the mutually adjacent connecting portions produced, the corrugated pipe is cut in order to provide in this manner individual corrugated pipes with an integrated connecting portion, in such a way that without further separate parts an end to end connection of the plastic corrugated pipes is possible. Only in the case where this connection is to provide a special sealing action, it may be required that a sealing element be provided in the connection region, for example an O-ring, a rubber sleeve, or the like in order to perform a sealing function in addition to the holing function, if the connecting parts themselves of the arrangement in accordance with the invention cannot provide a sufficient seal.

According to the invention, one of the connecting portions can also be provided by way of a fitting. This means that instead of providing both connecting parts at ends of plastic corrugated pipes, one of the connecting parts can be constructed in the form of a fitting, for example one which is manufactured by injection molding technology. This means that, for example, a cylindrical connection fitting can be constructed with features otherwise provided in accordance with the invention at one of the connecting parts of the mutually associated corrugated pipe ends. Such a fitting can be fastened, for example with a screwed connection, to a component, for example a switch gear cabinet, in order to fasten by way of this connecting fitting the corrugated pipe to be connected which includes the complementary connecting portion, to this component, for instance a switch gear cabinet.

The connecting part with the engagement extent is formed, preferably up to behind the engagement extent, with a cross-section or diameter for allowing the other connecting part to be received in the former or to receive the former. This construction enables an overlapping connection, whereby the components forming the mechanically secured connection can be engaged with one another, which means the engagement extent engages the holding region, whereby at the same time circumferential regions of the connection portion are present which are suited for sealing measures.

On the other hand, it is also advantageous when the other connecting part with the holding region is provided with a cross-section or diameter in such a way that it can receive the other connecting portion or can be received therein. Advantages are associated herewith which correspond to those already mentioned in the previous paragraph.

Preferably, the holding region includes a track or slide block guide or the like, whereby the engagement extent can be moved into a holding position along the track, the slide block guide or the like. This means the engagement extent is inserted into the track or slide block guide or the like at the start thereof and then moved along this track or slide block guide into the holding position.

The holding position is preferably constructed in such a way that it corresponds to a region of the track, the slide block guide or the like, which extends at least in part at more than 90° to the axially longitudinal direction of the associated holding region and/or the associated pipe body. The engagement extent hereby functions as slide block which is rigidly connected with the holding portion and which as soon as it has been guided into the holding position by way of the track, the slide block guide, or the like, securely connects the two pipe ends or the pipe end with the fitting. By providing the respective track or slide block guide or the like with a track or slide block guide portion which extends at 90° from the axially longitudinal direction of the associated holding portion and/or the associated pipe body, it is possible to achieve a fixed connection of the arrangement components to be connected by engagement, latching or twisting, which can only be separated again by an intentional action and in-so-far is reversible.

The track or slide block guide or the like preferably includes an undercut portion in such a way that the engagement extent can engage behind the undercut so that when the arrangement is to be separated again, the undercut must first be overcome before the engagement extent can again be released from the holding position by way of the track, the slide block guide, or the like.

The undercut preferably extends in circumferential direction and/or radially. When the undercut extends in circumferential direction, the engagement extent can be brought behind the undercut by way of the track, the slide block guide or the like, since a resilient force must be overcome so that under the action of normal traction on the arrangement in accordance with the invention, the undercut can no longer be overcome by the engagement extent. Correspondingly, it is possible to provide the undercut radially, so that the engagement extent must be radially inwardly or radially outwardly deflected in order to then engage the radial undercut when snapping back into its original radial position. Of course, it is possible to form a combination of a radially and circumferentially extending undercut, for example for special positioning requirements.

When the arrangement in accordance with the invention is to be specially sealed, for instance liquid tight, it is practical when at least one of the connecting portions is provided with a sealing device, while the other connecting portion should be equipped with a sealing surface in corresponding manner. For example, one connecting portion can be provided with a groove with an O-ring and the other portion with a sealing surface against which the O-ring is pressed in the connecting position for the sealing of the arrangement in accordance with the invention.

The connecting portions are preferably mutually correspondingly cylindrical or conical in construction, whereby especially a conical construction can provide that in the connecting position surfaces of the connecting cones can be directly and without additional sealing measures fitted into one another in such a way that a sufficient sealing action is achieved without further sealing measures. Of course, the sealingly engaging cones can also be provided with additional sealing measures, for example a rubber sleeve or the like, to guarantee the sealing action also for higher pressures.

It is especially preferred when the connecting portions together form a type of bayonet connection, whereby the corrugations of a corrugated pipe are especially suited to provide the possibly required restoring force for holding the engagement extent of the bayonet connection in a holding position, as long as the restoring force for the corrugated pipes is applied. In general, corrugated pipes are subject to tension forces, while to overcome such a restoring forces compression forces must be exerted to overcome the required resilient force which is exerted by the corrugations of a corrugated pipe of the arrangement in accordance with the invention.

If the invention is used, for example, for volatile or diffusive materials, especially fuels for motor vehicles, the plastic wall can be constructed of several layers, especially a diffusion blocking layer.

It is also preferred in accordance with the invention to provide one of the connecting parts, or also both, as containers which are to be connected in accordance with the invention.

### BRIEF DESCRIPTION OF THE DRAWINGS

The present invention will now be further described by reference to the attached drawings, whereby advantages, features and goals according to the invention are disclosed.

FIG. 1 shows a first embodiment in accordance with the invention partially in longitudinal section and partially in side elevation;

FIG. 1a shows a cross-section through the embodiment according to FIG. 1 in the area of section line A—A;

FIG. 2a is a side elevational view of a corrugated pipe with a first connecting part for insertion into a second connecting part;

FIG. 2b illustrates in partial cross-section and partial side elevation a corrugated pipe end with a second connecting part for receiving a first connecting part as shown in FIG. 2a;

FIG. 2c is an axial end view of the connecting part according to FIG. 2b;

FIG. 3a is a side elevational view of a corrugated pipe with a first connecting portion;

FIG. 3b is a partially cross-sectional partially side elevational view of a corrugated pipe with a connecting part corresponding to the connecting part shown in FIG. 3a; and

FIG. 4 is a side elevational view of a connection in accordance with the invention between a container and a corrugated pipe.

### DETAILED DESCRIPTION OF THE PREFERRED EMBODIMENTS

Equal or at least functionally equal components are identified by the same reference numerals in the various figures.

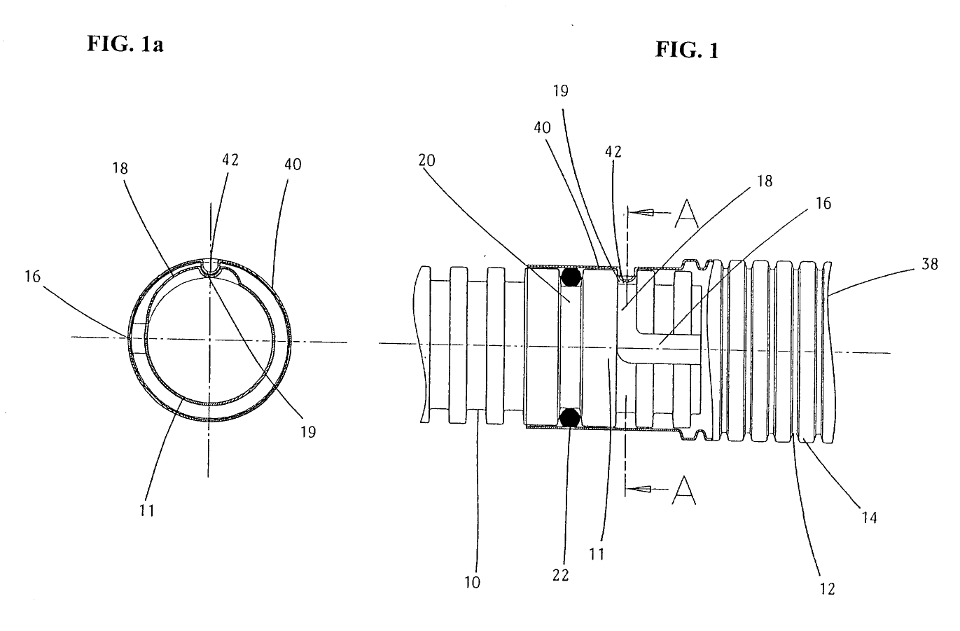

FIG. 1 shows a corrugated pipe 40 with a connecting part 11 according to the invention while another corrugated pipe 10 includes a connecting part 15 corresponding thereto.

As is apparent, the connecting parts 11 and 40 are constructed such that they can be plugged one into the other, whereby in this specific embodiment, the connecting part 40 can be inserted into the connecting part 11.

The corrugated pipe 38 has on its connecting part 40 an engagement extent 42 which upon fitting together of the arrangement can be brought into engagement with a radially extending undercut shape 19 by way of a track 16 and a track 18. The engagement extent 42 and/or the undercut portion 19 can thereby be constructed such that at least one radially evades the other, which is especially clearly apparent from FIG. 1a.

The connecting part 11 has a groove 20 into which an O-ring 22 is inserted. The sealing surface of the O-ring 22 rests against the wall of the connecting part 40 opposite thereto in such a way that a good sealing effect can be generated.

According to FIG. 1a, the connecting part 40 has an inwardly extending engagement extent 42 formed with the corrugation, which engages an undercut portion 19 equally formed by corrugation.

The start of the lead-in track 16 for the engagement extent 42 is apparent in this cross-sectional illustration. Joined to this track 16 is the track 18, which is constructed such that its depth decreases in circumferential direction towards the undercut portion 19. In this matter, the connecting part 11 can be inwardly deformed in the region of the track or the slide block guide 18 and then, when the engagement extent 42 has reached the undercut portion 19, snapped back into the original position in such a way that the engagement extent safely and fixedly comes to lie in the undercut portion 19. Of course the connecting part 40 can also be deformable to such an extent that its wall can be flexibly deformed so that the engagement extent 42 in the base of the track 18 evades in order to then again engage the undercut portion by way of the flexible resetting forces.

Since the components of the arrangement in accordance with the invention are made of plastic, the involved regions of the connecting part 11 as well as the connecting part 40 are in reality probably respectively gradually involved in the evading process.

It need not be stressed further that of course the undercut portion can conversely also be provided at the outer connecting part 40 and the engagement extent 42 at the inner connecting part 11.

The fastening process is hereby carried out in such a way that, as already mentioned above, the engagement extent 42 is inserted into the track 16, then inserted into the circumventially extending track 18 by rotation of one of the components of the arrangement to finally come to rest in the undercut portion 19. When tractive forces are then applied to this arrangement, they do then not act in direction of the resilient force which acts between the undercut portion 19 and the engagement extent 42 so that an opening of the connection in accordance with the invention is practically impossible. This equally also applies for thrust forces, since they also do not act radially inwardly.

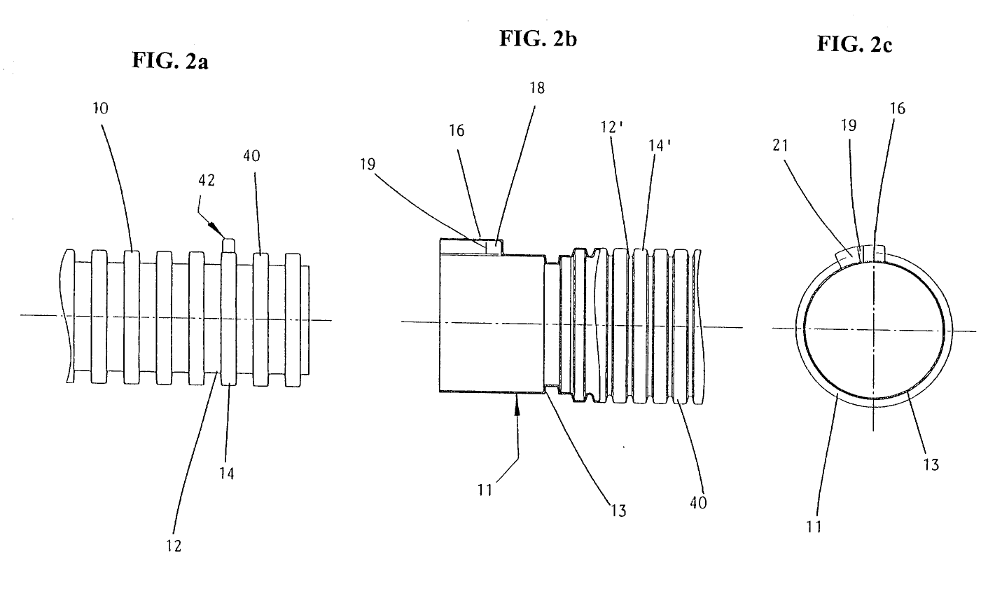

A further preferred embodiment with features according to the invention is apparent from FIGS. 2a to 2c.

A corrugated pipe section 10 with corrugation peaks 14 and corrugation valleys 12 here has an engagement extent 42 on one of the corrugation peaks. The opposing corrugated pipe 40 has a connecting part 11, which includes an initially axially extending track 19. This first, axially extending track 19 is joined to a circumferentially extending track portion 18 which then again turns into an essentially axially extending portion 21 as is apparent from FIG. 2c. An undercut portion 19 is provided between the two track portions 16 and 21, extending in axial direction of the pipe arrangement. At the end of the connecting part 11, a stop region is provided against which the end of the corrugated pipe 10 comes to rest.

When the two pipes 10, 40 are to be connected according to FIGS. 2a to 2c, the end of the pipe 10 is inserted into the connecting part 11, whereby the engagement extent 42 slides into the track 16 of the connecting part 11. The corrugated pipe 10 in this connecting process comes to rest against the stop region 13 and is during the connecting process compressed, which is made possible because of the corrugations. When the engagement extent 42 has reached the end of the track 16, a twisting force must be exerted on one of the two pipes 10, 40 or one of the two connecting parts 11, 40 so that the engagement extent 42 is transferred into the circumferentially extending track portion 18. As soon as the engagement extent 42 has passed through the circumferentially extending track portion 18 and thereby has automatically passed the undercut portion 19, the compression force which was exerted during the connecting process on the pipes 10, 40 involved therein, can be relaxed. The resetting resilient force of the corrugations of the corrugated pipe 10 in the region of the connecting part 40 can drive the engagement extent into the track portion 21 in such a way that a loosening of the arrangement components by tractive forces can no longer be achieved, since the engagement extent 42 is trapped behind the undercut portion 19 in the axially extending track portion 21. A loosening of this connection is only still possible when again a thrust force is exerted on the arrangement parts and especially on the pipe 10 to compress the corrugations in the region of the connecting part 40.

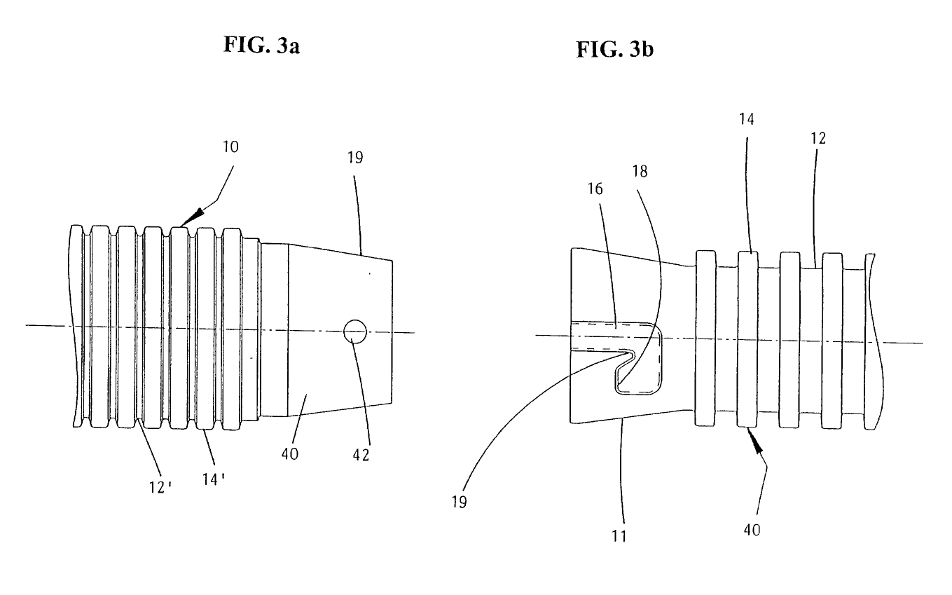

It is apparent from FIGS. 2a to 2c, FIGS. 1 and 1a, as well as FIGS. 3a and 3b that the corrugated pipes to be connected with one another can have different corrugation shapes. Of course, the corrugated pipes can also have identical corrugation shapes. It has to be noted with respect to all embodiments that in the case where one of the connecting parts 11, 40 is part of a connecting fitting, a threaded part or the like, for example, can of course then also adjoin the respective connecting part instead of the illustrated corrugated pipe.

An arrangement with features according to the invention is illustrated in the FIGS. 3a and 3b, which is principally constructed exactly as the embodiment according to FIGS. 2a to 2c. Different therefrom however are the connecting parts 11, 40 which are constructed to be mutually conically corresponding so that the conical surfaces coming in contact with one another can simultaneously represent sealing surfaces which provide a sufficient seal without having to take further sealing measures. On the other hand, it is also possible to incorporate, for example, a rubber sleeve into this arrangement so that an especially tightly sealed connection can be produced.

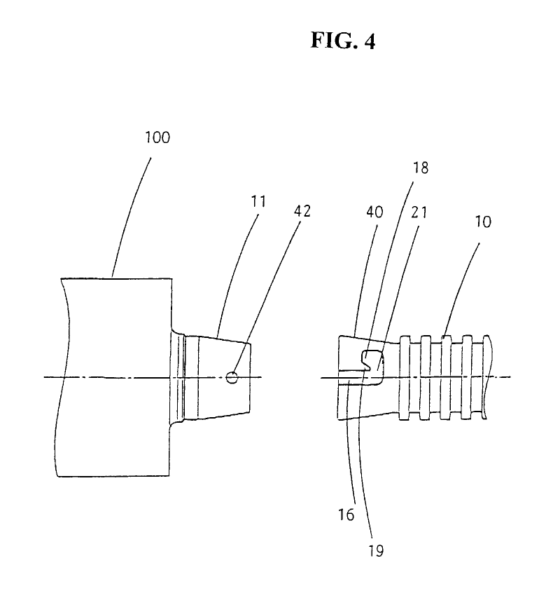

A container 100 is illustrated in FIG. 4, which is manufactured, for example, by injection molding or the like. The container is provided with a connecting part 11 according to the invention which includes the engagement extent 42. The corrugated pipe section 10 is provided with the connecting part 40 according to FIG. 3b.

Of course, the connecting part 11 of the container 100 can also be constructed according to one of the above mentioned other connecting parts 11, 40, whereby the respectively complementary connecting part is then provided on the corrugated pipe to be connected thereto. Of course, both connecting parts 11, 40 can be provided on containers 100.

1. Corrugated plastic pipe arrangement, comprising a first pipe body with corrugations extending transverse thereto and a second pipe body with corrugations extending transverse to the longitudinal axis, and a connecting portion for connecting the pipe bodies, the connecting portion including first and second connecting parts respectively integrally formed with one of the first and second pipe bodies, one connecting part having an engagement extent and the other connecting part having a holding region for holding the engagement extent.

2. Corrugated plastic pipe arrangement according to claim 1, wherein the pipe bodies are cylindrical and the holding region reversibly holds the engagement extent.

3. Corrugated plastic pipe arrangement according to claim 1, wherein the connecting part having the engagement extent is provided up to behind the engagement extent with a cross-section or diameter for receiving the connecting part having the holding region.

4. Corrugated plastic pipe arrangement according to claim 1, wherein the connecting part having the engagement extent is provided up to behind the engagement extent with a cross-section or diameter for being received in the connecting part having the holding region.

5. Corrugated plastic pipe arrangement according to claim 1, wherein the connecting part having the holding region is constructed with a cross-section or diameter for receiving the connecting part having the engagement extent.

6. Corrugated plastic pipe arrangement according to claim 1, wherein the connecting part having the holding region is constructed with a cross-section or diameter for being received in the connecting part having the engagement extent.

7. Corrugated plastic pipe arrangement according to claim 1, wherein the holding region includes one of a track and a slide block guide for guiding the engagement extent into a holding position.

8. Corrugated plastic pipe arrangement according to claim 7, wherein the holding position corresponds to a region of the track and the slide block guide, which at least partially extends at an angle less than 90° to the axially longitudinal direction of at least one of the associated holding region and the associated pipe body.

9. Corrugated plastic pipe arrangement according to claim 7, wherein the one of the track and the slide block guide includes an undercut portion.

10. Corrugated plastic pipe arrangement according to claim 9, wherein the undercut extends in a direction selected from the group of a circumferential direction and a radial direction.

11. Corrugated plastic pipe arrangement according to claim 1, wherein at least one of the connecting parts includes a sealing device.

12. Corrugated plastic pipe arrangement according to claim 11, wherein the sealing device is an O-ring.

13. Corrugated plastic pipe arrangement according to claim 1, wherein the connecting parts are constructed to be one of correspondingly cylindrical and correspondingly conical.

14. Corrugated plastic pipe arrangement according to claim 9, wherein in the case of corresponding conical connecting parts smooth, mutually opposite surfaces of the cones are constructed for sealingly interacting with one another.

15. Corrugated plastic pipe arrangement according to claim 1, wherein the connecting parts form a bayonet connection.

16. Corrugated plastic pipe arrangement according to claim 1, wherein one of the first and second connecting parts is provided on a corrugated pipe, while the other connecting part is constructed as a fitting.

17. Corrugated plastic pipe arrangement according to claim 16, wherein the fitting is constructed as an extruded plastic part

18. Corrugated plastic pipe arrangement according to claim 1, wherein one of the first and second connecting parts is provided on a corrugated pipe, while the other connecting pipe is provided on a container.

19. Plastic corrugated pipe arrangement according to claim 1, wherein both connecting parts are provided on a container.

20. Corrugated plastic pipe arrangement, comprising a first pipe body with corrugations extending transversely thereto and a second pipe body with corrugations extending transverse to its longitudinal axis, and a connecting portion for connecting the pipe bodies to one another, the connecting portion having first and second connecting parts respectively integrally formed with one of the first and second pipe bodies, one connecting part having an engagement extent and the other connecting part having a holding region for reversibly holding the engagement extent and including one of a track and a slide block guide for guiding the engagement extent into the holding position.

21. Corrugated plastic pipe arrangement, comprising a first pipe body with corrugations extending transversely thereto and a second pipe body with corrugations extending transverse to its longitudinal axis, and a connecting portion for connecting the pipe bodies with one another, the connecting portion having first and second connecting parts respectively integrally formed on one of the first and second pipe bodies, one connecting part having an engagement extent and the other connecting part having a holding region for reversibly holding the engagement extent and including one of a track and a slide block guide for guiding the engagement extent into the holding position; wherein the one of the track and the slide block guide has an undercut portion which in axial direction of the connecting portion or the cylindrical pipe body extends opposite to the direction of the one of the track and the slide block guide.

22. Corrugated plastic pipe arrangement according to claim 20 or 21, wherein the pipe bodies are of cylindrical construction.
